(19) United States
(12) Patent Application Publication
(10) Pub. No.: US 2024/0296249 A1
(43) Pub. Date: Sep. 5, 2024

(54) INTEGRITY VERIFICATION SYSTEM OF CIRCUIT INFORMATION AND INTEGRITY VERIFICATION METHOD OF CIRCUIT INFORMATION

(71) Applicant: Nippon Telegraph and Telephone Corporation, Tokyo (JP)

(72) Inventors: Yurika SUGA, Musashino-shi, Tokyo (JP); Takao YAMASHITA, Musashino-shi, Tokyo (JP)

(21) Appl. No.: 18/571,370

(22) PCT Filed: Jun. 28, 2021
(86) PCT No.: PCT/JP2021/024405

§ 371 Date: Dec. 18, 2023

(51) Int. Cl. G06F 21/64

(52) U.S. Cl. CPC G06F 21/64

(57) ABSTRACT

In an integrity verification system (1) for circuit information, a CPU (100) includes, in a protection area (130), a signature verification unit (132) that verifies a signature of circuit information (11) signed by a development PC (10) and transmitted to a concerned CPU (100), and a signature replacement unit (135) that replaces a signature verified by the signature verification unit (132) with a signature using a key of a concerned CPU (100) before the circuit information (11) is transmitted to an FPGA (200), and the FPGA (200), in a case where an input value (12) is transmitted from the CPU (100), performs calculation on the basis of the input value (12), adds hash values of the input value (12) and the circuit information (11) and a signature to an output value of the calculation, and transmits the output value to the CPU (100).

### TECHNICAL FIELD

The present invention relates to an integrity verification system for circuit information between a CPU and an accelerator and an integrity verification method for circuit information.

### BACKGROUND ART

There are increasing examples in which a part of processing of a software application (hereinafter, referred to as an APL) is offloaded to an accelerator such as a graphics processing unit (GPU) or a field programmable gate array (FPGA) to implement performance and power efficiency that cannot be achieved if only using software (CPU processing).

A case is assumed in which an accelerator as described above is applied in a large-scale server cluster such as a data center included in network functions virtualization (NFV) or a software defined network (SDN).

As a technology for guaranteeing integrity, an attack in which the OS/driver/BIOS/VMM is compromised can be prevented by a protection area (enclave) being provided in a memory in a CPU and important information being stored in the protection area (enclave). Furthermore, in the APL, a state in which the OS and the VMM are trusted can be changed to a state in which only a protected area of the hardware, which is a more limited area, is trusted, and accordingly, the load on the APL can be reduced.

There is tampering as a possible threat when circuit information to be customized by the FPGA (the circuit information is algorithm information in a case of a GPU) and information regarding a calculation process are exchanged between the protection area (enclave) in the CPU and the GPU or FPGA device that performs processing.

As information that may be tampered with, for example, circuit information for performing arithmetic in the FPGA, a value transmitted from the CPU to the FPGA for calculation, and a value transmitted from the FPGA to the CPU can be considered. Being able to confirm and detect that information that may be tampered with has not been tampered with is necessary.

Conventional communication between an Enclave and a GPU or an FPGA will be described (see Non Patent Literature 1).

### <Communication System Between Enclave and FPGA>

FIG. 26 is a schematic configuration diagram of a communication system between an Enclave and an FPGA. The FPGA is taken as an example of an accelerator.

As illustrated in FIG. 26, the communication system between the Enclave and the FPGA includes a development PC 10, an input value generation source 20, a CPU 30, and an FPGA 40 that is an accelerator that performs offloaded calculation.

The development personal computer (PC) 10 is operated by a function manager 2, and creates circuit information 11 set in advance in order to offload calculation in the FPGA using the PC resource.

The input value generation source 20 generates an input value 12 necessary for offloading.

The CPU 30 includes an external Enclave memory 31, a protection area (enclave) 32, and an FPGA transfer function program 33. The FPGA transfer function program 33 is a function program performed by the CPU 30. In the following description, the notation in which the FPGA transfer function program 33 is described as an entity is a notion in which a function in which the CPU 30 performs the FPGA transfer function program 33 is described for convenience.

In FIG. 26, the circuit information 11 is input from the development PC 10 to the external Enclave memory 31 (see S1), and the input value 12 (input value necessary for offloading) is input from the input value generation source 20 (see S2). The external Enclave memory 31 stores the input circuit information 11.

The protection area (enclave) 32 includes a program 34 for management and verification for preventing tampering. In FIG. 26, the protection area (enclave) 32 stores the circuit information 11 and the input value 12.

The FPGA transfer function program 33 receives information of the external Enclave memory 31 (see S3) and transfers the information to the protection area (enclave) 32 (see S4). Here, the FPGA transfer function program 33 transfers the circuit information 11 and the input value 12 to the protection area (enclave) 32. The FPGA transfer function program 33 reads information (here, input value 12) of the protection area (enclave) 32 (see S5).

The FPGA transfer function program 33 transmits important information (here, circuit information 11, input value 12) stored in the protection area (enclave) 32 in the CPU 30 to the FPGA 40 (see S6, S7), and receives a calculation result (output value 13 that is a result of offloading, calculating, and outputting) using an arithmetic circuit 41 from the FPGA 40 (see S8).

The CPU 30 transmits the circuit information 11 to the FPGA 40, causes the FPGA 40 to form the arithmetic circuit 41, and offloads a part of processing of the APL to the FPGA 40. The FPGA 40 performs arithmetic using the arithmetic circuit 41 for the offloaded APL processing and transfers the arithmetic result to the CPU 30.

The FPGA 40 includes the arithmetic circuit 41 and a RAM 42. The arithmetic circuit 41 calculates offloaded processing of the APL (see S8), and outputs the output value 13 that is the arithmetic result to the RAM 42.

The RAM 42 temporarily stores information (circuit information 11, input value 12) from the CPU 30 transferred by the FPGA transfer function program 33, and temporarily stores a calculation result (output value 13) that is obtained by using the arithmetic circuit 41 and is to be transferred to the CPU 30.

### <Possibility of Tampering>

There is tampering as a threat that can be considered when the circuit information 11 and information regarding a calculation process (for example, input value 12) are exchanged between the protection area (enclave) 32 in the CPU 30 and the FPGA 40 that performs processing (see reference signs a and b in FIG. 26).

As information that may be tampered with, tampering of the circuit information 11 for performing arithmetic in the FPGA 40 and a value transmitted from the CPU to the FPGA for calculation (circuit information 11, input value 12) (see reference signs c and d in FIG. 26), and tampering of a value transmitted from the FPGA to the CPU (output value 13) (see a reference sign e in FIG. 26) can be considered.

Being able to confirm and detect that information that may be tampered with has not been tampered with is necessary.

<Communication System Between Enclave and FPGA in which Possibility of Tampering is Coped With>

The following is considered as a precondition in a case of constructing a communication system between the Enclave and the FPGA in which the possibility of tampering is coped with.
The FPGA 40 can confirm the reliability of the circuit information 11 and the input value 12 transferred from the protection area (enclave) 32 in the CPU 30.
The CPU 30 can confirm the reliability of the output value 13 transferred from the FPGA 40.
As indicated by reference signs a to d in FIG. 26, tampering of the circuit information 11, the input value 12, and the output value 13 is assumed in each communication path.
A function user 2 trusts the protection area (enclave) 32 in the CPU 30.

FIG. 27 is a schematic configuration diagram of the communication system between the Enclave and the FPGA in which the possibility of tampering is coped with. The same components as those in FIG. 26 are denoted by the same reference signs. FIG. 28 is a diagram illustrating a signature to the circuit information 11 using a secret key (signature provider) 51 by a signature provider 50.

As illustrated in FIG. 27, the communication system between the Enclave and the FPGA in which the possibility of tampering is coped with further includes the signature provider 50 (signature providing device) in the communication system between the Enclave and the FPGA of FIG. 26.

The signature provider 50 is an input terminal device used by a person who provides a signature to the circuit information 11.

The signature provider 50 includes the secret key (signature provider) 51, a public key (signature provider) 52, and a signature (signature provider) 53.

As indicated by a reference sign f in FIG. 28, the signature provider 50 generates a signature to the circuit information 11 using the secret key (signature provider) 51. The signature provider 50 provides the secret key (signature provider) 51, the public key (signature provider) 52, and the signature (signature provider) 53 to the development PC 10 (see S11).

The development PC 10 illustrated in FIG. 27 transmits the circuit information 11 to which the public key (signature provider) 52 and the signature (signature provider) 53 are provided to the external Enclave memory 31 of the CPU 30 (see S1).

The FPGA transfer function program 33 of the CPU 30 illustrated in FIG. 27 transfers the circuit information 11 to which the public key (signature provider) 52 and the signature (signature provider) 53 are provided and the input value 12 to the protection area (enclave) 32 (see S1).

The FPGA transfer function program 33 transmits important information (here, circuit information 11 to which the public key (signature provider) 52 and the signature (signature provider) 53 are provided, input value 12) stored in the protection area (enclave) 32 in the CPU 30 to the FPGA 40 (see S6, S7), and receives a calculation result (here, output value 13) obtained by using the arithmetic circuit 41 from the FPGA 40 (see S8).

The RAM 42 temporarily stores the information (circuit information 11 to which the public key (signature provider) 52 and the signature (signature provider) 53 are provided, input value 12) from the CPU 30 transferred by the FPGA transfer function program 33, and temporarily stores the calculation result (output value 13) that is obtained by using the arithmetic circuit 41 and is to be transferred to the CPU 30.

### CITATION LIST

### Non Patent Literature

Non Patent Literature 1: Elrabaa, M. E. S. et al. “Secure Computing Enclaves Using FPGAs”. IEEE Transactions on Dependable and Secure Computing 18 (2021): 593-604.

### SUMMARY OF INVENTION

### Technical Problem

In the conventional art, as illustrated in FIG. 26, there is the protection area (enclave) 32 for preventing tampering in the CPU 30. However, in a case where the circuit information 11, the information regarding a calculation process, and the like are exchanged between the protection area in the CPU 30 and the FPGA 40 that performs processing, there is possibility that the information is tampered with during the exchange (see reference signs a to e in FIG. 26). In this case, there is an issue that confirming and detecting that tampering has not been performed are not possible.

Furthermore, as illustrated in FIG. 27, there is an issue that the processing load on the FPGA 40 increases in a case where signature verification is performed using a public key or the like. Specific description will be given.

The signature verification (tracing whether the public key is correct) is performed by the FPGA 40 (see FIG. 27), which puts a load on the FPGA 40. Furthermore, complicated processing (signature verification, management of a plurality of public keys, and the like) in the FPGA 40 is difficult. Moreover, as indicated by a reference sign g in FIG. 27, the signature verification is processing that puts a load on the FPGA, and there is an issue that the load further increases in consideration of verification of the input value 12 used for calculation. It takes time for the FPGA to output a result.

Note that, although verifying a signature by the FPGA 40 is conceivable regarding the circuit information 11, the processing load increases in a case where a plurality of input values is considered.

The present invention has been made in view of such a background, and an object of the present invention is to enable confirmation of integrity that circuit information and the like are not tampered with, and to enable reduction of the processing load of an FPGA.

### Solution to Problem

In order to solve the above issues, the present invention is an integrity verification system for circuit information, including a CPU and an accelerator that performs specific processing of an application offloaded from the CPU, and verifies integrity of circuit information between a CPU and an accelerator, in which the CPU includes a protection area for preventing tampering, and includes, in the protection area, a signature verification unit that verifies a signature of the circuit information signed by a development PC and transmitted to a concerned CPU, and a signature replacement unit that replaces a signature verified by the signature verification unit with a signature using a key of a concerned CPU before the circuit information is transmitted to the accelerator, and the accelerator, in a case where an input value is transmitted from the CPU, performs calculation on the basis of the input value, adds hash values of the input value and the circuit information and a signature to an output value of the calculation, and transmits the output value to the CPU.

### Advantageous Effects of Invention

According to the present invention, integrity that circuit information and the like are not tampered with can be confirmed, and the processing load of an FPGA can be reduced.

### BRIEF DESCRIPTION OF DRAWINGS

FIG. 1 is a diagram illustrating a configuration example of an integrity verification system for circuit information according to an embodiment of the present invention.

FIG. 2 is an operation explanatory diagram of <Writing of Circuit Information (CPU Side)> of the integrity verification system for circuit information according to the embodiment of the present invention.

FIG. 3 is a diagram illustrating signature verification of circuit information by a signature verification unit of a CPU of the integrity verification system for circuit information according to the embodiment of the present invention.

FIG. 4 is a control sequence diagram of <Writing of Circuit Information (CPU Side)> of the integrity verification system for circuit information of FIG. 2.

FIG. 5 is an operation explanatory diagram of <Writing of Circuit Information to FPGA> of the integrity verification system for circuit information according to the embodiment of the present invention.

FIG. 6 is a diagram illustrating hash value generation of the CPU of the integrity verification system for circuit information according to the embodiment of the present invention.

FIG. 7 is a diagram illustrating a signature of the circuit information by a secret key (CPU) of a signature generation unit of the CPU of the integrity verification system for circuit information according to the embodiment of the present invention.

FIG. 8 is a diagram illustrating signature verification of an FPGA of the integrity verification system for circuit information according to the embodiment of the present invention.

FIG. 9 is a diagram illustrating hash value generation of the FPGA of the integrity verification system for circuit information according to the embodiment of the present invention.

FIG. 10 is a control sequence diagram of <Writing of Circuit Information to FPGA> of the integrity verification system for circuit information of FIG. 5.

FIG. 11 is a diagram illustrating a signature of a random number by a secret key (FPGA) of the FPGA of the integrity verification system for circuit information according to the embodiment of the present invention.

FIG. 12 is an operation explanatory diagram of <Activation After Writing> of the integrity verification system for circuit information according to the embodiment of the present invention.

FIG. 13 is an operation explanatory diagram of <Output of Arithmetic Result Using Circuit> of the integrity verification system for circuit information according to the embodiment of the present invention.

FIG. 14 is a diagram illustrating a signature of an input value by a secret key (input value generation source) of an input value generation source of the integrity verification system for circuit information according to the embodiment of the present invention.

FIG. 15 is a diagram illustrating signature verification of the FPGA of the integrity verification system for circuit information according to the embodiment of the present invention.

FIG. 16 is a control sequence diagram of <Activation After Writing-Output of Arithmetic Result Using Circuit> of the integrity verification system for circuit information according to the embodiment of the present invention.

FIG. 17 is a diagram illustrating a signature of an input value by a secret key of an input value generation source (input value generation source) of the integrity verification system for circuit information according to the embodiment of the present invention.

FIG. 18 is a diagram illustrating a signature of a random number by a secret key (FPGA) of the FPGA of the integrity verification system for circuit information according to the embodiment of the present invention.

FIG. 19 is an operation explanatory diagram of <Output Result Transmission> of the integrity verification system for circuit information according to the embodiment of the present invention.

FIG. 20 is a diagram illustrating key pair generation of a public key (FPGA) and the secret key (FPGA) of the integrity verification system for circuit information according to the embodiment of the present invention.

FIG. 21 is a diagram illustrating hash value generation of the FPGA of the integrity verification system for circuit information according to the embodiment of the present invention.

FIG. 22 is a diagram illustrating a signature of hash values of an input value and circuit information and an output value of the FPGA of the integrity verification system for circuit information according to the embodiment of the present invention.

FIG. 23 is a diagram illustrating hash value verification of the circuit information and the input value of the integrity verification system for circuit information according to the embodiment of the present invention.

FIG. 24 is a control sequence diagram of <Output Result Transmission> of the integrity verification system for circuit information according to the embodiment of the present invention.

FIG. 25 is a diagram illustrating signature verification of a signature (FPGA) provided to the output value using the public key (FPGA) of the CPU of the integrity verification system for circuit information according to the embodiment of the present invention.

FIG. 26 is a schematic configuration diagram of a conventional communication system between an Enclave and an FPGA.

FIG. 27 is a schematic configuration diagram of a conventional communication system between the Enclave and the FPGA in which possibility of tampering is coped with.

FIG. 28 is a diagram illustrating a signature to the circuit information using a secret key (signature provider) of a signature provider of the communication system between the Enclave and the FPGA in FIG. 27.

### DESCRIPTION OF EMBODIMENTS

Hereinafter, a network system and the like according to a mode for carrying out the present invention (hereinafter, referred to as “present embodiment”) will be described with reference to the drawings.

### Embodiment

In the present embodiment, an FPGA is taken as an example of an accelerator, and a CPU is taken as an example of a general-purpose server.

### [Configuration of Integrity Verification System 1 for Circuit Information]

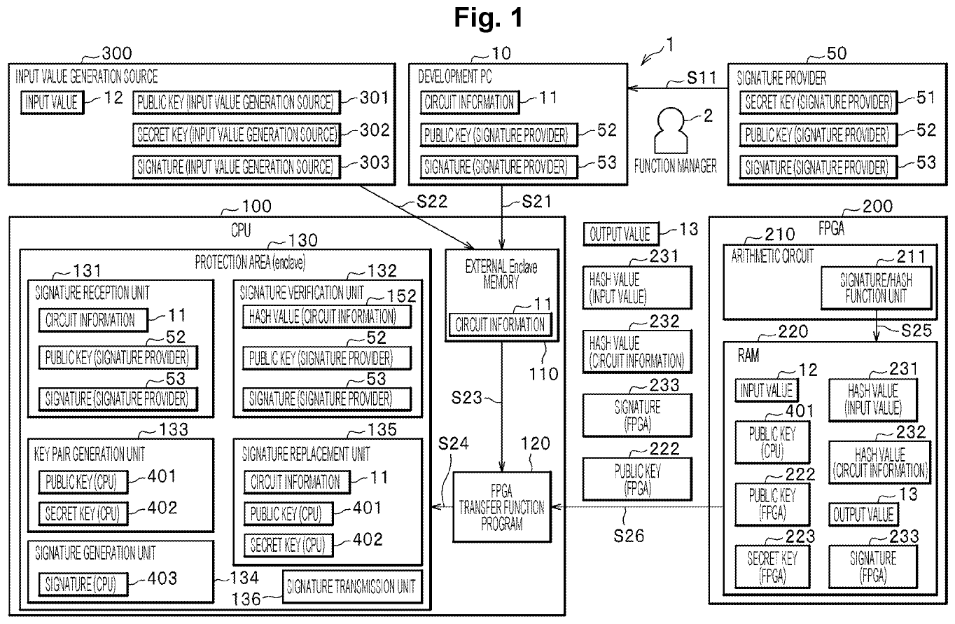

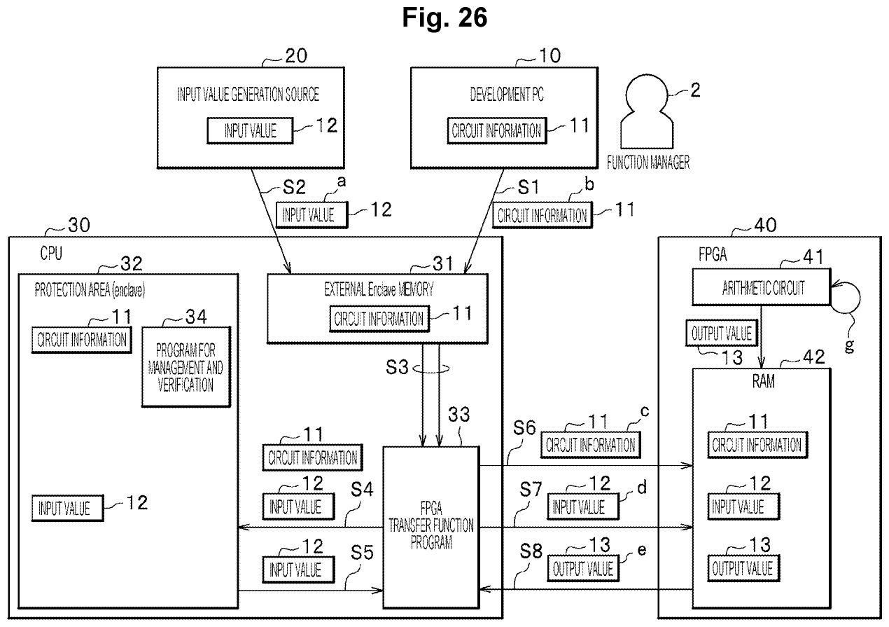

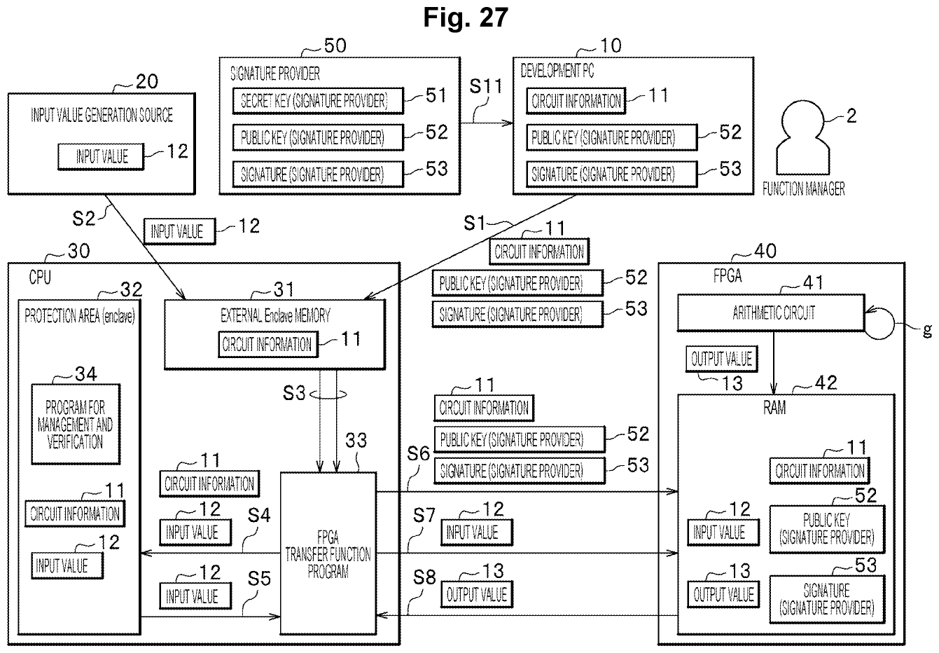

FIG. 1 is a diagram illustrating a configuration example of an integrity verification system 1 for circuit information between the CPU and the accelerator according to the embodiment of the present invention. The same components as those in FIGS. 26 and 27 are denoted by the same reference signs as those in FIGS. 26 and 27.

The integrity verification system 1 for circuit information illustrated in FIG. 1 includes a CPU 100, an FPGA 200 (accelerator), and an input value generation source 300. Furthermore, a development PC 10 is connected to the CPU 100, and a signature provider 50 is connected to the development PC 10.

### <Development PC 10>

The development PC 10 creates circuit information 11 set in advance in order to offload calculation in the FPGA, and transmits the circuit information 11 to the signature provider 50 (not illustrated). In <Writing of Circuit Information (CPU Side)>, the development PC 10 transmits the circuit information 11, a public key (signature provider) 52, and a signature (signature provider) 53 to the CPU 100.

### <Signature Provider 50>

The signature provider 50 provides a signature to the circuit information 11 created and transmitted by the development PC 10, and transmits the circuit information 11 to the development PC 10 (see S11). The signature provider 50 generates the signature to the circuit information 11 using the secret key (signature provider) 51. The signature provider 50 provides the secret key (signature provider) 51, the public key (signature provider) 52, and the signature (signature provider) 53 to the development PC 10.

### <CPU 100>

The CPU 100 includes an external Enclave memory 110, an FPGA transfer function program 120, and a protection area (enclave) 130 for preventing tampering.

The external Enclave memory 110 is a normal area in which a normal application or the like operates. The CPU 100 performs an application program using the external Enclave memory 110.

The FPGA transfer function program 120 is a program for transferring data between the CPU and the accelerator (CPU 100 and FPGA 200). The FPGA transfer function program 120 may be referred to as an FPGA transfer function unit or an FPGA transfer management unit.

In <Writing of Circuit Information (CPU Side)>, the CPU 100 receives the circuit information 11, the public key (signature provider) 52, and the signature (signature provider) 53 transmitted from the development PC 10, and performs signature verification of the circuit information 11 transmitted from the development PC 10. The signature verification is performed using the public key (signature provider) 52.

In <Writing of Circuit Information to FPGA>, the CPU 100 confirms a signature of information transmitted to the FPGA 200 side and replaces the signature.

The CPU 100 receives hash values of an input value and the circuit information and an output value to which a signature is provided that are transmitted from the FPGA 200, and verifies the hash values and the signature. At this time, the CPU 100 confirms (attests) that the FPGA 200, which is the other party, is a trusted FPGA on the basis of a certificate and the signature of the FPGA.

### <Protection Area 130>

The protection area (enclave) 130 is a protected area on hardware for preventing an attack that compromises OS/driver/basic input/output system (BIOS)/virtual machine manager (VMM). The protection area (enclave) 130 is provided in the CPU 100. The protection area (enclave) 130 is a secure area in which a public key, a secret key, circuit information 11, and the like are confined in the CPU 100. By the protection area (enclave) 130 being provided, a state in which the application trusts the OS and the VMM can be changed to a state in which only a protected area of the hardware is trusted.

Here, the protection area (enclave) 130 is an execution environment isolated from a general application program, and data and calculation processing are protected. Execution in a privileged mode of the CPU or the operating system (OS) is performed, and a program of the protection area (enclave) 130 can be called or data can be accessed only by a specific program or a specific procedure.

The protection area (enclave) 130 stores a signature reception unit 131, a signature verification unit 132, a key pair generation unit 133, a signature generation unit 134, a signature replacement unit 135, and a signature transmission unit 136.

The signature reception unit 131 receives the circuit information 11, the public key (signature provider) 52, and the signature (signature provider) 53 transmitted from the development PC 10.

The signature verification unit 132 verifies a signature of the signature (signature provider) 53 received by the signature reception unit 131.

The signature verification unit 132 verifies a signature of the circuit information 11 signed by the development PC 10 and transmitted to the CPU 100.

Furthermore, the signature verification unit 132 verifies a signature of the input value 12 signed by the generation source of the input value 12 and transmitted to the CPU 100.

Furthermore, the signature verification unit 132 performs signature verification by comparing a hash value (CPU) 152 of the circuit information 11 with a hash value calculated by the signature provider 50 (calculated from a received signature (CPU) 403 and a public key (CPU) 401).

Furthermore, the signature verification unit 132 verifies a hash value and a signature transmitted from the FPGA 200.

Furthermore, the signature verification unit 132 calculates a hash value (bit string) using algorithm of a hash function such as message digest algorithm 5 (MD5) or secure hash algorithm (SHA). The same hash algorithm needs to be used in both the CPU 100 and the FPGA 200.

The key pair generation unit 133 generates a key pair on the basis of the public key (CPU) 401 and a secret key (CPU) 402.

After calculating the hash value (CPU) 152 of the circuit information 11, the signature generation unit 134 performs signing (signature (CPU) 403) using the hash value (CPU) 152 and the secret key (CPU) 402.

The signature replacement unit 135 provides the signature (CPU) 403 generated by the signature generation unit 134 and the public key (CPU) 401 to the circuit information 11. That is, the signature replacement unit 135 confirms a signature of information transmitted to the FPGA 200 and replaces the signature using a key of the CPU.

The signature replacement unit 135 replaces the signature verified by the signature verification unit 132 with a signature using the key of the CPU 100 before the circuit information 11 is transmitted to the FPGA 200.

Furthermore, the signature replacement unit 135 replaces the signature verified by the signature verification unit 132 with a signature using the key of the CPU 100 before the input value 12 is transmitted to the FPGA 200.

The signature transmission unit 136 transmits the circuit information 11, the public key (CPU) 401 of the CPU, and the signature (CPU) 403 of the CPU to the FPGA 200. On the basis of this, the FPGA 200 performs signature verification and generates a hash value.

### <FPGA 200>

The FPGA 200 is an accelerator provided on an accelerator board (not illustrated). In the present embodiment, the FPGA is taken as an example of the accelerator, but an accelerator of a GPU or the like may be used.

In a case where the input value 12 is transmitted from the CPU 100, the FPGA 200 performs calculation on the basis of the input value 12, adds the hash values of the input value 12 and the circuit information 11 and a signature to the output value, and transmits the output value to the CPU 100.

The FPGA 200 generates a key pair.

The FPGA 200 generates a hash value of an input value.

The FPGA 200 registers a public key in advance among the public key and a secret key generated by the CPU 100, and verifies the signature of the circuit information 11 signed by the CPU 100 and transmitted to the FPGA 200 using the registered public key.

The FPGA 200 transmits hash values of an input value and circuit information and an output value to which a signature is provided to the CPU 100. In FIG. 1, the FPGA 200 adds a hash value (circuit information) 232, a hash value (input value) 231, and a signature (FPGA) 233 to an output result (output value 13) and transmits the result to the CPU 100. The CPU 100 performs verification of hash values and a signature received from the FPGA 200.

### <Input Value Generation Source 300>

The input value generation source 300 transmits a public key (input value generation source) 301, a secret key (input value generation source) 302, and a signature (input value generation source) 303 to the external Enclave memory 110 of the CPU 100 (see S22).

Hereinafter, an integrity verification method for circuit information of the integrity verification system 1 for circuit information formed as described above will be described.

The gist of the present invention is that the circuit information 11 developed by the development PC 10 is verified once by the CPU 100 and then sent to the FPGA 200 without being directly sent to the FPGA 200. The circuit information 11, the circuit information 11, the public key (signature provider) 52, and the signature (signature provider) 53 are held in the protection area (enclave) 130 and verified in the CPU 100. Then, after the verification, the input value 12 and the output value 13 are verified only using a public key of a key pair of the CPU 100. A signature and a public key are not the original signature (signature provider) 53 and the public key (public key (signature provider) 52), but the CPU 100 performs conversion into the signature (CPU) 403 and the public key (public key (CPU) 401) of the CPU 100 and transmits the signature (CPU) 403 and the public key (public key (CPU) 401) of the CPU 100 to the FPGA 200. In a case where the input value 12 is transmitted from the CPU 100, the FPGA 200 performs calculation on the basis of the input value 12, adds the hash values of the input value 12 and the circuit information 11 and the signature (signature (FPGA) 233) to the output value 13, and transmits the output value 13 to the CPU 100. By the CPU 100 performing verification thereof, it can be known that it is certain and there is no tampering.

In the integrity verification system 1 for circuit information illustrated in FIG. 1, stages are divided into <Writing of Circuit Information (CPU Side)>, <Writing of Circuit Information to FPGA>, <Writing of Circuit Information (FPGA Side)>, <Activation After Writing>, <Output of Arithmetic Result Using Circuit>, <Activation After Writing-Output of Arithmetic Result Using Circuit>, and <Output Result Transmission>, and will be described with reference to operation explanatory diagrams of devices used in the stages and control sequence diagrams.

In each of the following control sequence diagrams, for convenience of description, processing between the CPU 100 and the FPGA 200 and the like are integrated into one flow. Therefore, processing in the CPU 100 and processing in the FPGA 200 and the like are performed asynchronously. Notification and permission between the two are required between the CPU 100 and the FPGA 200 and the like.

### <Writing of Circuit Information (CPU Side)>

Writing of circuit information (CPU side) will be described.

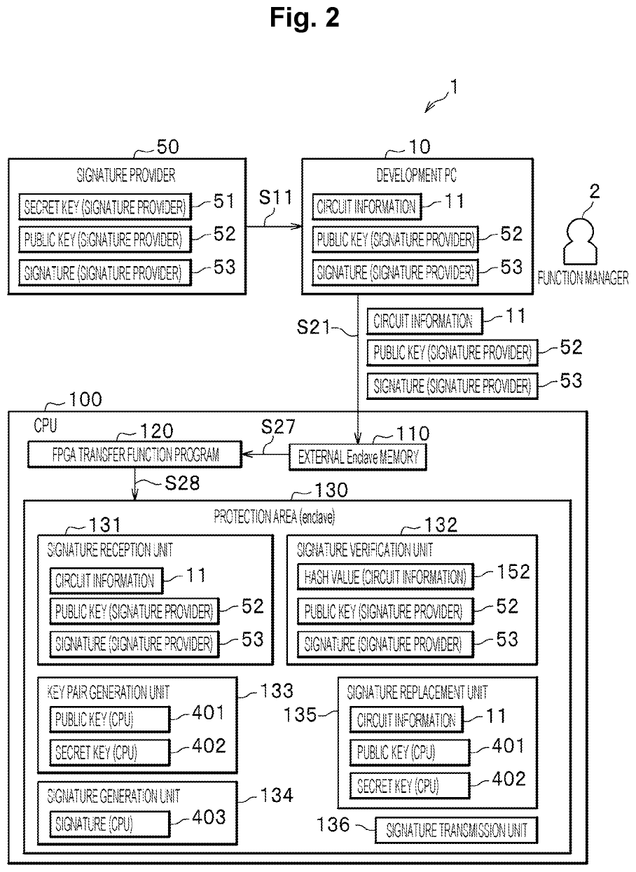

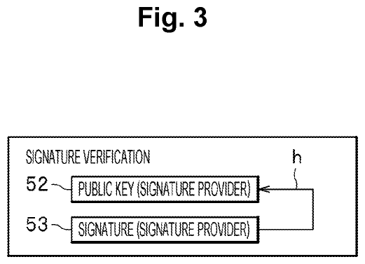

FIG. 2 is an operation explanatory diagram of <Writing of Circuit Information (CPU Side)> of the integrity verification system 1 for circuit information between the CPU and the FPGA 200. FIG. 3 is a diagram illustrating signature verification of the circuit information 11 by the signature verification unit 132 of the CPU 100.

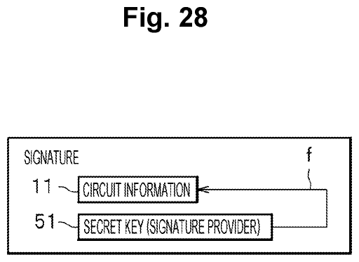

As illustrated in FIG. 2, in <Writing of Circuit Information (CPU Side)> operation, the development PC 10 creates the circuit information 11 and transmits the circuit information 11 to the signature provider 50. As indicated by the reference sign f in FIG. 28, the signature provider 50 generates a signature to the circuit information 11 using the secret key (signature provider) 51. The signature provider 50 provides the secret key (signature provider) 51, the public key (signature provider) 52, and the signature (signature provider) 53 to the development PC 10 (see S11).

Since the signature provider 50 guaranteed by a trusted third party (certificate authority (CA), public key certificate certification authority or certification authority) signs the circuit information 11 and the signature is provided to the circuit information 11, the CPU 30 of a transmission destination can verify whether the circuit information 11 has been tampered with.

The development PC 10 transmits the circuit information 11 to which the public key (signature provider) 52 and the signature (signature provider) 53 are provided to the external Enclave memory 110 of the CPU 100 (see S21).

The FPGA transfer function program 120 of the CPU 100 transmits, to the signature verification unit 132 of the CPU 100, the circuit information 11 to which the public key (signature provider) 52 and the signature (signature provider) 53 temporarily stored in the external Enclave memory 110 are provided (see S27, S28).

As indicated by a reference sign h in FIG. 3, the signature verification unit 132 performs signature verification of the circuit information 11 encrypted with the public key (signature provider) 52 using the signature (signature provider) 53.

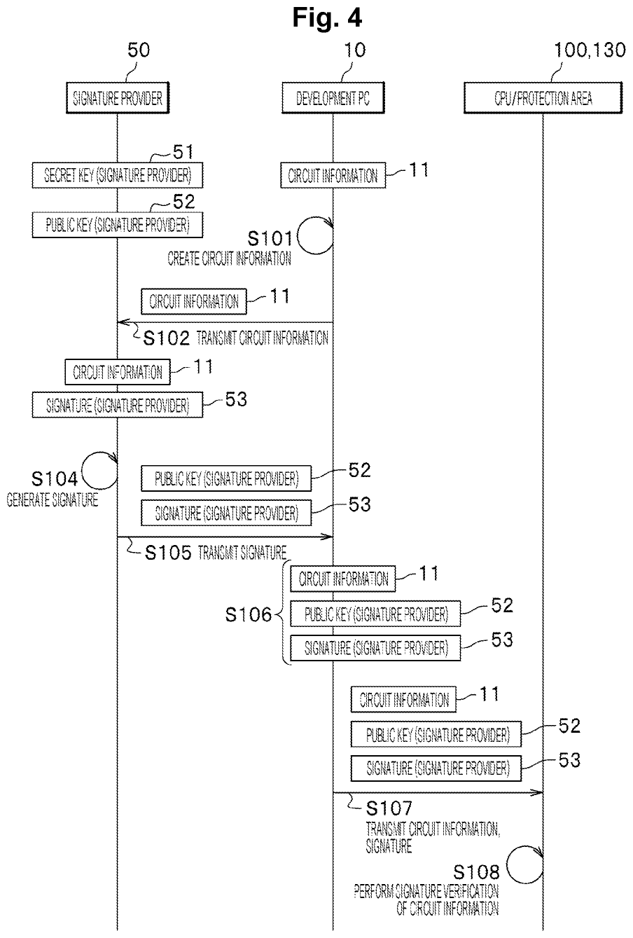

FIG. 4 is a control sequence diagram of <Writing of Circuit Information (CPU Side)> of the integrity verification system 1 for circuit information between the CPU and the accelerator of FIG. 2.

The development PC 10 receives original data of the circuit information 11, and creates the circuit information 11 (see S101).

The development PC 10 transmits the created circuit information 11 to the signature provider 50 (see S102).

On the other hand, the signature provider 50 inputs the secret key (signature provider) 51 and the public key (signature provider) 52 (see S103).

The signature provider 50 generates a signature by providing a signature (signature provider) to the circuit information 11 transmitted from the development PC 10 using the secret key (signature provider) 51 (see S104).

The signature provider 50 transmits the public key (signature provider) 52 and the signature (signature provider) 53 by which the signature is generated to the development PC 10 (see S105).

The development PC 10 puts together the created circuit information 11 and the public key (signature provider) 52 and the signature (signature provider) 53 by which the signature provider 50 has generated the signature (see S106). The development PC 10 transmits the circuit information 11, the public key (signature provider) 52, and the signature (signature provider) 53 (transmits the circuit information and the signature) to the CPU 100 (see S107).

The CPU 100 performs signature verification of the circuit information 11 by the signature verification unit 132 (see FIG. 2) disposed in the protection area (enclave) 130 (see S108). That is, as indicated by the reference sign h in FIG. 3, the signature verification unit 132 performs signature verification of the circuit information 11 encrypted with the public key (signature provider) 52 using the signature (signature provider) 53.

<Writing of Circuit Information (CPU Side)> has been described above.

### <Writing of Circuit Information to FPGA>

Writing of circuit information to FPGA will be described.

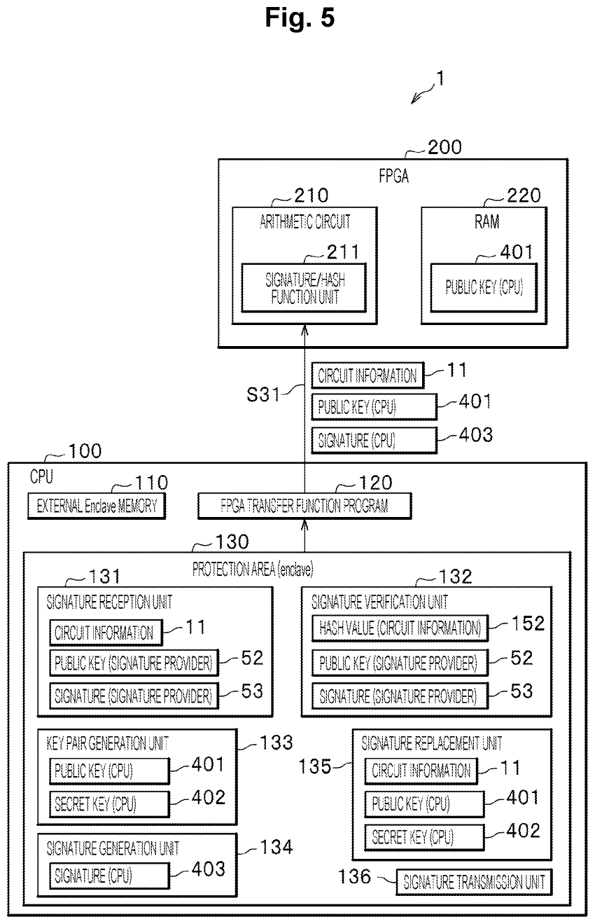

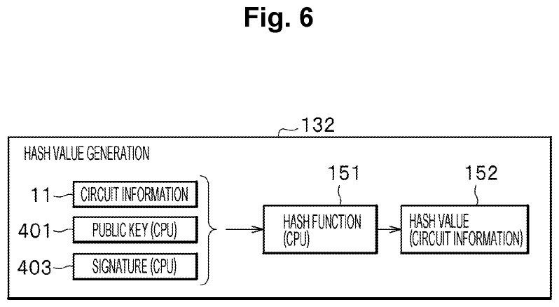

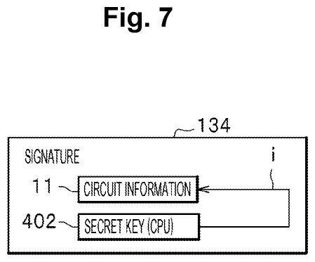

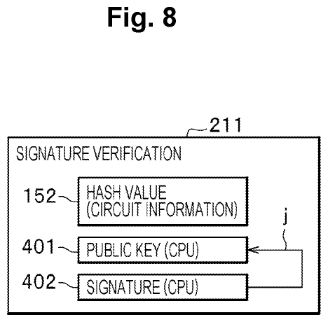

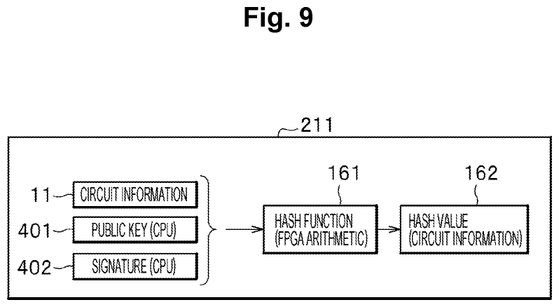

FIG. 5 is an operation explanatory diagram of <Writing of Circuit Information to FPGA> of the integrity verification system 1 for circuit information. FIG. 6 is a diagram illustrating hash value generation by the CPU 100. FIG. 7 is a diagram illustrating a signature of the circuit information 11 by the secret key (CPU) 402 of the signature generation unit 134 of the CPU 100. FIG. 8 is a diagram illustrating signature verification of the FPGA 200. FIG. 9 is a diagram illustrating hash value generation of the FPGA 200.

As illustrated in FIG. 5, in <Writing of Circuit Information to FPGA> operation, the signature verification unit 132 of the CPU 100 verifies a signature of the signature provider 50 in the signature reception unit 131. Specifically, it is as follows. As illustrated in FIG. 6, the signature verification unit 132 inputs the circuit information 11, the public key (CPU) 401, and the signature (CPU) 402, and generates the hash value (circuit information) 152 using a hash function (CPU) 151. The signature verification unit 132 performs signature verification by comparing the hash value (circuit information) 152 of the circuit information 11 with a hash value calculated by a signer (calculated from the received signature (signature provider) 53 and the public key (signature provider) 52).

The key pair generation unit 133 of the CPU 100 generates a key pair of the public key (CPU) 401 and the secret key (CPU) 402.

The signature generation unit 134 of the CPU 100 signs the circuit information 11 (see FIG. 7). As indicated by a reference sign i in FIG. 7, the signature generation unit 134 signs (CPU) the circuit information 11 by performing calculation using a hash value and the secret key (CPU) 402 after the signature verification unit 132 calculates the hash value of the circuit information 11.

The signature replacement unit 135 of the CPU 100 provides the signature (CPU) 402 generated by the signature generation unit 134 and the public key (CPU) 401 to the circuit information 11. That is, the signature replacement unit 135 confirms a signature of information transmitted to the FPGA 200 and replaces the signature using a key of the CPU 100.

In FIG. 5, the signature (signature provider) 53 of the signature provider 50 verified and confirmed in <Writing of Circuit Information (CPU Side)> illustrated in FIGS. 2 to 4 is replaced with a signature (re-signed) using a key (public key (CPU) 401) of the CPU 100 and is set as the signature (CPU) 403.

The CPU 100 confirms (attests) that the FPGA 200, which is the other party is a trusted FPGA on the basis of a certificate and a signature of the FPGA with the FPGA 200.

The signature transmission unit 136 of the CPU 100 transmits the circuit information 11, the public key (CPU) 401 of the CPU 100, and the signature (CPU) 403 of the CPU 100 to the FPGA 200 (see S31).

In the FPGA 200, a signature/hash function unit 211 of an arithmetic circuit 210 performs signature verification and generates a hash value. Specifically, it is as follows.

First, the public key (CPU) 401 is registered in the RAM 220 of the FPGA 200 in advance among the public key (CPU) 401 and the secret key (CPU) 402 generated by the CPU 100.

As illustrated in FIG. 8, the signature/hash function unit 211 performs signature verification by comparing the hash value (circuit value) 152 of the circuit information 11 with a hash value calculated by the CPU 100 (calculated from the received signature (CPU) 403 and the public key (CPU) 401).

As illustrated in FIG. 9, the signature/hash function unit 211 inputs the circuit information 11, the public key (CPU) 401, and the signature (CPU) 403, and generates a hash value (circuit information) 162 using a hash function (FPGA arithmetic) 161.

As described above, the hash function (FPGA arithmetic) 161 calculates a hash value (bit string) using, for example, algorithm of a hash function such as MD5 or SHA. The same hash algorithm is used in both the CPU 100 and the FPGA 200.

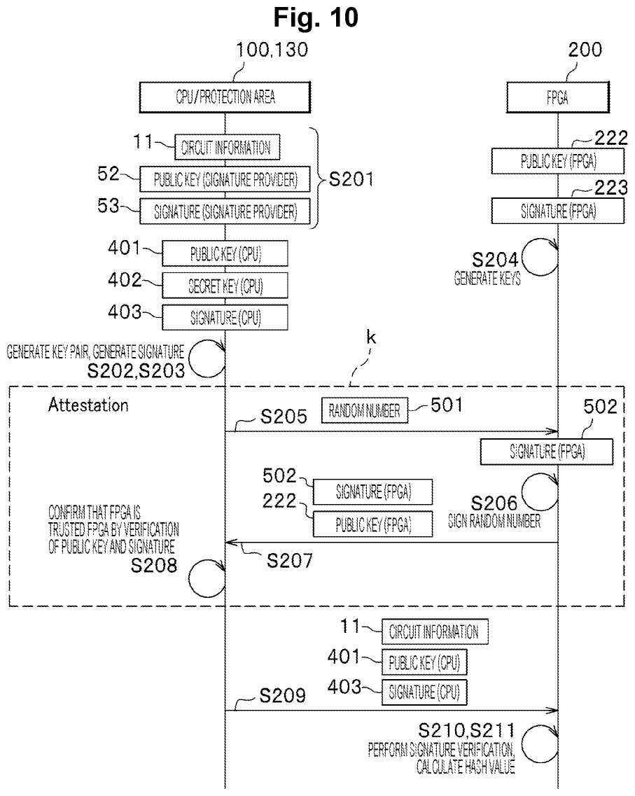

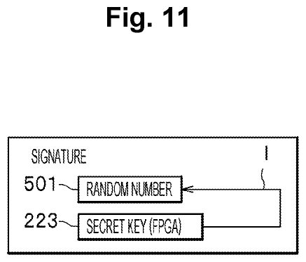

FIG. 10 is a control sequence diagram of <Writing of Circuit Information to FPGA> of the integrity verification system 1 for circuit information between the CPU and the FPGA 200 of FIG. 5. FIG. 11 is a diagram illustrating a signature of a random number 501 by a secret key (FPGA) 223 of the FPGA 200.

The CPU 100 receives the circuit information 11, the public key (signature provider) 52, and the signature (signature provider) 53 transmitted from the development PC 10 (see FIG. 2) by the signature reception unit 131 (see FIG. 5) disposed in the protection area (enclave) 130 (see S201).

The key pair generation unit 133 of the CPU 100 (see FIG. 5) generates a key pair of the public key (CPU) 401 and the secret key (CPU) 402 (see S202).

As indicated by the reference sign i in FIG. 7, the signature generation unit 134 of the CPU 100 (see FIG. 5) signs the circuit information 11 by performing calculation using a hash value and the secret key (CPU) 402 after the signature verification unit 132 (see FIG. 5) calculating the hash value of the circuit information 11 (see S203).

The signature replacement unit 135 of the CPU 100 (see FIG. 5) provides the signature (CPU) 402 generated by the signature generation unit 134 and the public key (CPU) 401 to the circuit information 11, thereby replacing the signature (CPU) 402 using the public key (CPU) 401 of the CPU 100.

On the other hand, the FPGA 200 generates a key pair of a public key (FPGA) 222 and a secret key (FPGA) 223 (see S204).

### <Attestation >

As indicated by a broken line box k in FIG. 10, the CPU 100 confirms (attests) that the FPGA 200, which is the other party, is a trusted FPGA on the basis of a certificate and a signature of the FPGA with the FPGA 200.

First, the CPU 100 transmits the random number 501 to the FPGA 200 (see S205).

As indicated by a reference sign 1 in FIG. 11, the FPGA 200 signs the random number 501 and creates a signature (FPGA) 502 by performing calculation using the random number 501 transmitted from the CPU 100 and the secret key (FPGA) 223 (see S206).

The FPGA 200 transmits the signature (FPGA) 502 and the public key (FPGA) 222 to the CPU 100 (see S207).

The CPU 100 confirms that the FPGA is a trusted FPGA by verification of the public key (FPGA) 222 and the signature (FPGA) 502 (see S208). The above is confirmation (attestation).

The CPU 100 transmits the circuit information 11, the public key (CPU) 401 of the CPU 100, and the signature (CPU) 402 of the CPU 100 to the FPGA 200 that has been confirmed to be a trusted FPGA (see S209).

As illustrated in FIG. 8, the FPGA 200 performs signature verification by comparing the hash value (circuit value) 152 of the circuit information 11 with a hash value calculated by the CPU 100 (calculated from the received signature (CPU) 402 and the public key (CPU) 401) (see S210). As illustrated in FIG. 9, the FPGA 200 inputs the circuit information 11, the public key (CPU) 401, and the signature (CPU) 403, and generates the hash value (circuit information) 162 using the hash function (FPGA arithmetic) 161 (see S211).

In the arithmetic circuit 210 of the FPGA 200, the signature/hash function unit 211 performs signature verification and generates a hash value. Specifically, it is as follows.

First, the public key (CPU) 401 is registered in the RAM 220 of the FPGA 200 in advance among the public key (CPU) 401 and the secret key (CPU) 402 generated by the CPU 100.

The signature/hash function unit 211 inputs the circuit information 11, the public key (CPU) 401, and the signature (CPU) 403, and generates the hash value (circuit information) 162 using the hash function (FPGA arithmetic) 161. The signature/hash function unit 211 performs signature verification by comparing the hash value (circuit value) 162 of the circuit information 11 with a hash value calculated by the CPU 100 (calculated from the received signature (CPU) 402 and the public key (CPU) 401). <Writing of Circuit Information to FPGA> has been described above.

### <Activation After Writing>

Activation after writing will be described.

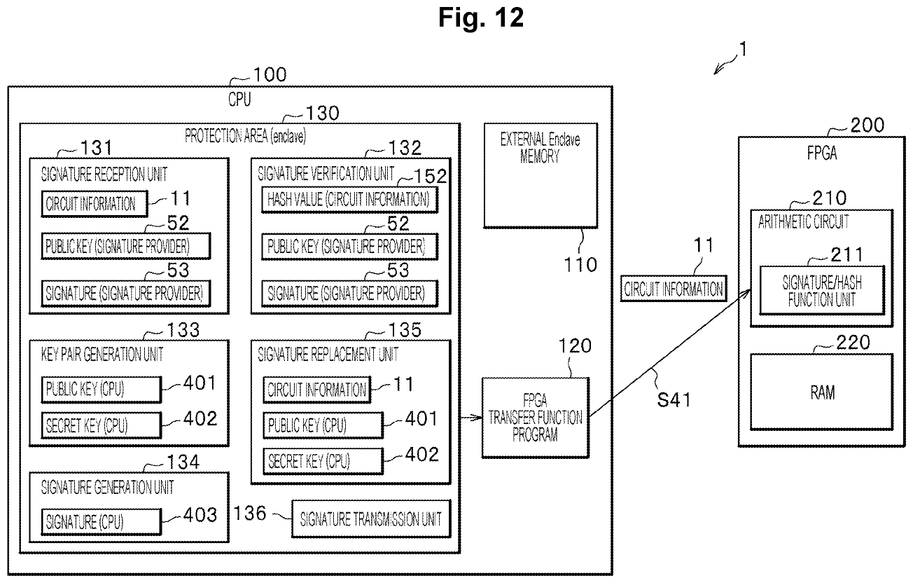

FIG. 12 is an operation explanatory diagram of <Activation After Writing> of the integrity verification system 1 for circuit information between the CPU and the accelerator.

In a case where the FPGA 200 stores data using an external memory, a procedure of activation after writing illustrated in FIG. 12 is added.

The FPGA transfer function program 120 of the CPU 100 reads the circuit information 11 of the signature replacement unit 135 disposed in the protection area (enclave) 130 and transmits the circuit information 11 to the FPGA 200 (see S41).

A circuit of the FPGA 200 is set on the basis of the circuit information 11 transmitted from the CPU 100 when the power is turned on.

### <Output of Arithmetic Result Using Circuit>

An arithmetic result output using a circuit will be described.

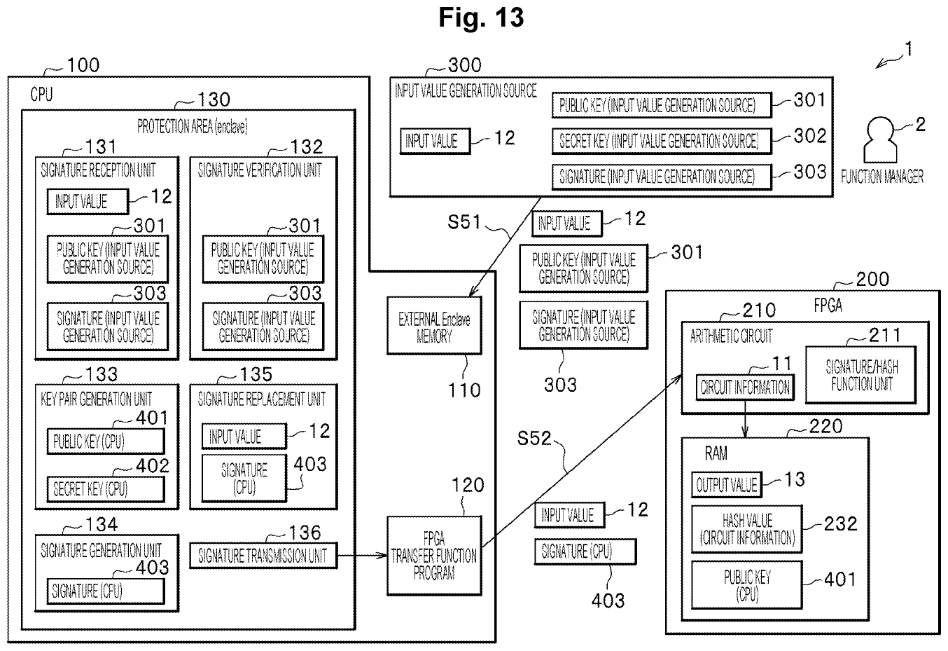

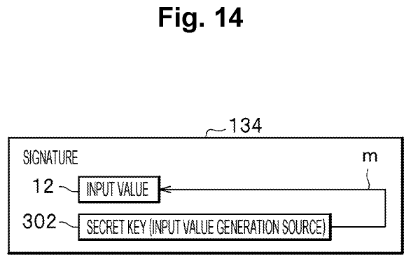

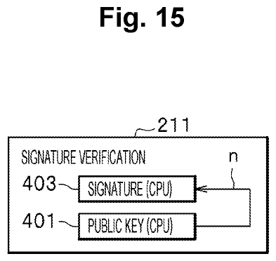

FIG. 13 is an operation explanatory diagram of <Output of Arithmetic Result Using Circuit> of the integrity verification system 1 for circuit information between the CPU and the FPGA 200. FIG. 14 is a diagram illustrating a signature of the input value 12 by the secret key (input value generation source) 302 of the input value generation source 300. FIG. 15 is a diagram illustrating signature verification of the FPGA 200.

As described in FIG. 13, the input value generation source 300 includes the input value 12, the public key (input value generation source) 301, the secret key (input value generation source) 302, and the signature (input value generation source) 303. Since there is a trusted third party such as the input value generation source 300, confirmation processing as to whether the public key is trusted can be greatly reduced. That is, in a case where there is no third party, replacing a public key is necessary in addition to confirming whether entities can be mutually trusted. In a case where there is a third party, each of the entities may confirm a public key of the trusted third party.

In <Writing of Circuit Information to FPGA> operation, the input value generation source 300 signs the input value 12 using the secret key (input value generation source) 302 as indicated by a reference sign m in FIG. 14.

The input value generation source 300 transmits the input value 12, the public key (input value generation source) 301, and the signature (input value generation source) 303 to the external Enclave memory 110 of the CPU 100 (see S51).

The signature reception unit 131 of the CPU 100 receives the input value 12, the public key (input value generation source) 301, and the signature (input value generation source) 303 transmitted from the input value generation source 300.

The signature verification unit 132 of the CPU 100 performs signature verification of the input value 12. That is, the signature verification unit 132 performs signature verification of the input value 12 encrypted with the public key (input value generation source) 52 using the signature (input value generation source) 303.

As indicated by the reference sign m in FIG. 14, the signature generation unit 134 of the CPU 100 signs the input value 12 transmitted from the input value generation source 300 using the secret key (input value generation source) 302 to generate the signature (CPU) 403.

The signature replacement unit 135 of the CPU 100 signs the input value 12 using a key of the CPU 100. That is, the signature replacement unit 135 replaces the signature of the input value 12 similarly to the circuit information 11 illustrated in FIG. 5.

The signature transmission unit 136 of the CPU 100 transmits the input value 12 to which the signature has been replaced by the signature replacement unit 135 and the signature (CPU) 403 to the FPGA 200 using the FPGA transfer function program 120 (see S52).

In the arithmetic circuit 210 of the FPGA 200, the signature/hash function unit 211 performs signature verification. Specifically, it is as follows.

As indicated by a reference sign n in FIG. 15, the signature/hash function unit 211 performs signature verification by comparing a hash value calculated by the CPU 100 (calculated from the received signature (CPU) 403 and the public key (CPU) 401).

The arithmetic circuit 210 of the FPGA 200 includes a circuit set on the basis of the circuit information 11 transmitted from the CPU 100, and calculates the output value 13 on the basis of the input value 12 using this circuit. The arithmetic result using the circuit is temporarily stored in the RAM 220 together with the output value 13, the hash value (circuit information) 232, and the public key (CPU) 401 of the CPU 100.

<Output of Arithmetic Result Using Circuit> has been described above.

<Activation After Writing-Output of Arithmetic Result Using Circuit>

Activation after writing-output of arithmetic result using circuit will be described.

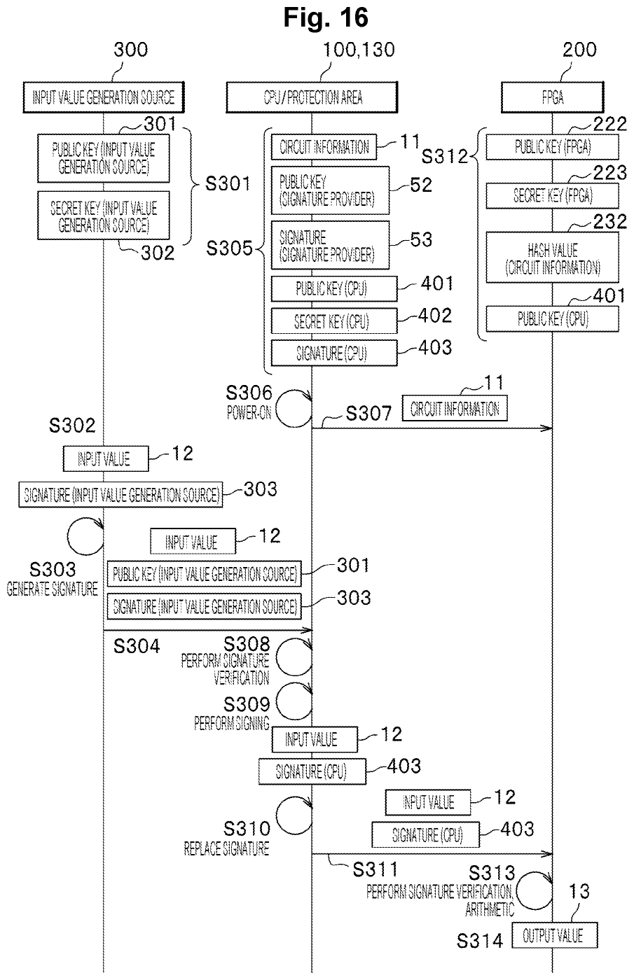

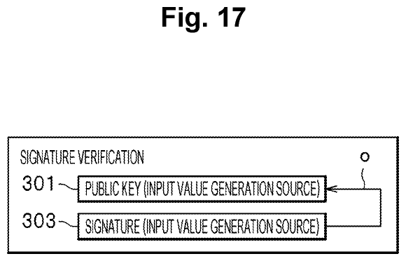

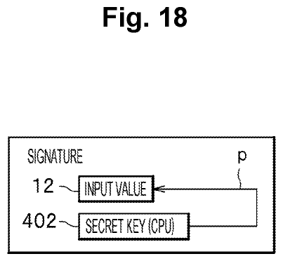

FIG. 16 is a control sequence diagram of <Activation After Writing-Output of Arithmetic Result Using Circuit> of the integrity verification system 1 for circuit information between the CPU and the FPGA 200. FIG. 17 is a diagram illustrating a signature of the input value 12 by the secret key (input value generation source) 302 of the input value generation source 300. FIG. 18 is a diagram illustrating a signature of the random number 501 by the secret key (FPGA) 223 of the FPGA 200.

In <Activation After Writing-Output of Arithmetic Result Using Circuit> operation, the input value generation source 300 outputs the public key (input value generation source) 301 and the secret key (input value generation source) 302 (see S301).

The input value generation source 300 signs the input value 12 using the signature (input value generation source) 302 (see S302).

The input value generation source 300 generates a signature of the input value 12 (see S303).

The input value generation source 300 transmits the input value 12, the public key (input value generation source) 301, and the signature (input value generation source) 303 to the CPU 100 (see S304).

On the other hand, the CPU 100 receives the circuit information 11, the public key (signature provider) 52, the signature (signature provider) 53, the public key (CPU) 401, the secret key (CPU) 402, and the signature (CPU) 403 transmitted from the development PC 10 (see FIG. 2) by the signature reception unit 131 (see FIG. 5) disposed in the protection area (enclave) 130 (see S305).

The CPU 100 transmits the circuit information 11 to the FPGA 200 (see S307) using the power-on as a trigger (see S306).

As indicated by a reference sign o in FIG. 17, the CPU 100 performs signature verification of the public key (input value generation source) 301 using the signature (input value generation source) 303 (see S308).

As indicated by a reference sign p in FIG. 18, the CPU 100 signs the input value 12 using the secret key (CPU) 402 (see S309).

The CPU 100 re-signs (replaces the signature of) the input value 12 using the signature (CPU) 403 (see S310).

Re-signing in the protection area will be described. The re-signing in the protection area includes “circuit information”, “circuit information+input value”, and “circuit information+input value+output value”.

The effect of re-signing is as follows. That is, there is an effect of reducing public keys managed by the FPGA 200. In a case where the re-signing is not performed, verification using various public keys is required in the FPGA 200. In a case where a method for confirming reliability of a public key is “is the public key included in a certificate that can be traced from a root CA trusted by the recipient?”, tracing the certificate from the root CA is necessary. Furthermore, since the certificate may be invalidated after being issued once, checking invalidation is also necessary. In this manner, verification that the certificate is a reliable certificate is a burden on the FPGA 200.

The CPU 100 transmits the re-signed input value 12 and the signature (CPU) 403 to the FPGA 200.

On the other hand, the FPGA 200 receives the public key (FPGA) 222, the secret key (FPGA) 223, the hash value (circuit information) 232 transmitted from the CPU 100, and the public key (CPU) 401 transmitted from the CPU 100 (see S312).

The FPGA 200 performs signature verification and arithmetic using a circuit on the basis of the re-signed circuit information 11 transmitted from the CPU 100 (see S307) and the re-signed input value 12 and signature (CPU) 403 transmitted from the CPU 100 (see S311) in addition to the public key (FPGA) 222, the secret key (FPGA) 223, the hash value (circuit information) 232, and the public key (CPU) 401 (see S313). As indicated by a reference sign n in FIG. 15, the signature verification in above S313 is signature verification in which a hash value calculated by the CPU 100 (calculated from the received signature (CPU) 402 and the public key (CPU) 401) is compared.

The FPGA 200 outputs the output value 13 and ends the <Activation After Writing-Output of Arithmetic Result Using Circuit> sequence.

<Activation After Writing-Output of Arithmetic Result Using Circuit> has been described above

### <Output Result Transmission>

Output result transmission will be described.

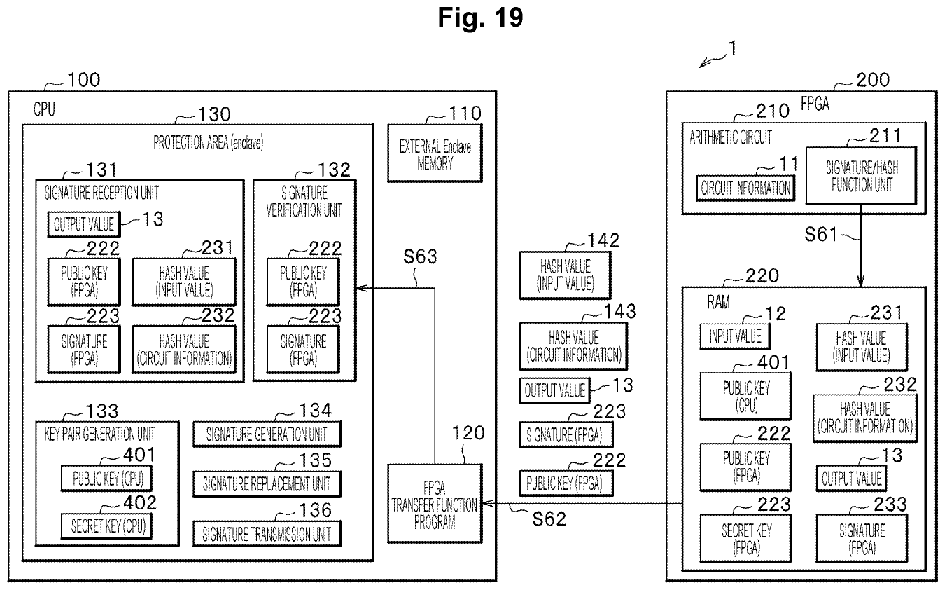

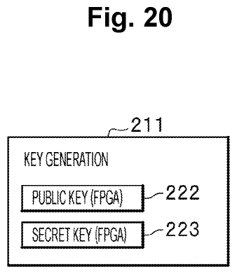

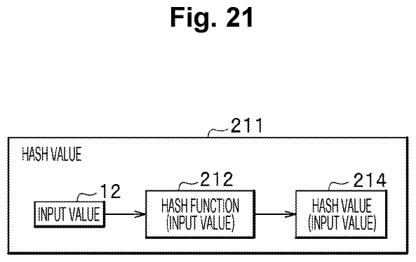

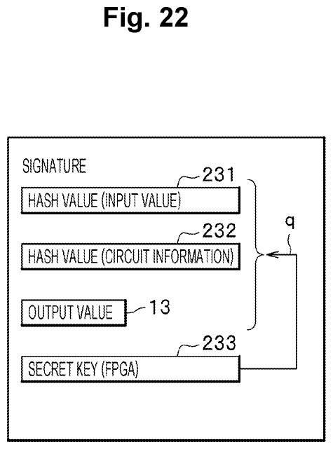

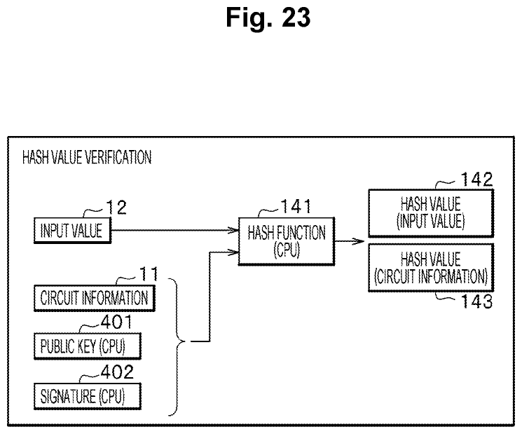

FIG. 19 is an operation explanatory diagram of <Output Result Transmission> of the integrity verification system 1 for circuit information between the CPU and the accelerator. FIG. 20 is a diagram illustrating key pair generation of the public key (FPGA) 222 and the secret key (FPGA) 223 of the FPGA 200. FIG. 21 is a diagram illustrating hash value generation of the FPGA 200. FIG. 22 is a diagram illustrating an input value of the FPGA 200, a hash value of circuit information, and a signature of an output value. FIG. 23 is an explanatory diagram of hash value verification of the circuit information 11 and the input value 12.

As illustrated in FIG. 19, in <Output Result Transmission> operation, the FPGA 200 generates a key pair and a hash value of the input value 12. Specifically, it is as follows. In the FPGA 200, the signature/hash function unit 211 of the arithmetic circuit 210 generates a key pair of the public key (FPGA) 222 and the secret key (FPGA) 223 as illustrated in FIG. 20.

As illustrated in FIG. 21, the signature/hash function unit 211 of the arithmetic circuit 210 generates the hash value (input value) 214 using the hash function (input value) 212.

There are two methods, that is, a method of mounting these hash value and key generation functions in the FPGA 200 as circuit information of the FPGA 200 and a method of preliminarily building a circuit in an integrated circuit of the FPGA 200 or in another portion (that is, change cannot be made thereafter), and either one may be used. In a case of using a current product, there is a case where the functions cannot be implemented without using the former, but there is a case where, ideally, it is preferable that such functions of protecting security cannot be modified thereafter.

The arithmetic result by the arithmetic circuit 210 is output to the RAM 220 (see S61). The RAM 220 temporarily stores the hash value (input value) 231, the hash value (circuit information) 232, the output value 13, and the signature (FPGA). Furthermore, the RAM 220 temporarily stores the input value 12, the public key (CPU) 401 of the CPU 100, the public key (FPGA) 222 of the FPGA 200, and the secret key (FPGA) 223 of the FPGA 200.

The FPGA 200 signs the hash value (input value) 231 and the hash value (circuit information) 232, which are hash values of the input value and the circuit information, and the output value 13 using the secret key (FPGA) 233 as indicated by a reference sign q in FIG. 22.

The FPGA 200 transmits the hash value (input value) 231, the hash value (circuit information) 232, the signature (FPGA) 223 provided to the output value 13, and the public key (FPGA) 222 to the CPU 100 (see S62).

The CPU 100 performs verification of hash values and a signature. Specifically, the hash value verification is as follows. As illustrated in FIG. 23, the CPU 100 inputs the input value 12, the circuit information 11, the public key (CPU) 401, and the signature (CPU) 402, and generates a hash value (input value) 142 and a hash value (circuit information) 143 using a hash function (CPU) 141.

Note that attestation for confirming that the CPU 100 is a reliable FPGA may be performed at the time of verification of the hash values and the signature.

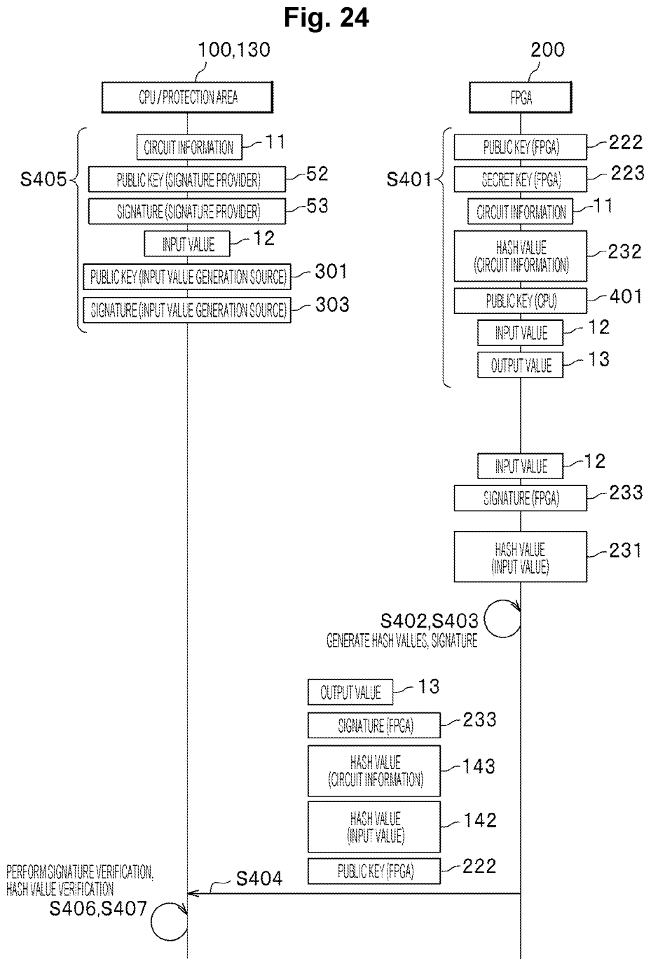

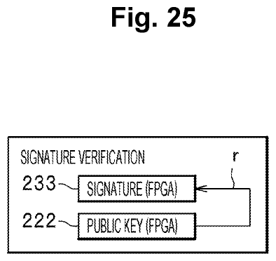

FIG. 24 is a control sequence diagram of <Output Result Transmission> of the integrity verification system 1 for circuit information between the CPU and the accelerator of FIG. 19. FIG. 25 is a diagram illustrating signature verification of the signature (FPGA) 223 provided to the output value 13 using the public key (FPGA) 222 of the CPU 100.

In <Output Result Transmission> operation, the FPGA 200 takes in the public key (FPGA) 222, the secret key (FPGA) 223, the circuit information 11, the hash value (circuit information) 232, the public key (CPU) 401, the input value 12, and the output value 13 (see S401).

The FPGA 200 signs the hash value (input value) 231 and the hash value (circuit information) 232, which are hash values of the input value and the circuit information, and the output value 13 using the secret key (FPGA) 233 as indicated by the reference sign q in FIG. 22 (see S402).

As illustrated in FIG. 21, the FPGA 200 generates the hash value (input value) 214 using the hash function (input value) 212 (see S403).

The FPGA 200 transmits the hash value (input value) 231, the hash value (circuit information) 232, the signature (FPGA) 223 provided to the output value 13, and the public key (FPGA) 222 to the CPU 100 (see S404).

On the other hand, the CPU 100 receives the circuit information 11, the public key (signature provider) 52, the signature (signature provider) 53, the input value 12, the public key (input value generation source) 301, and the signature (input value generation source) 303 transmitted from the development PC 10 (see FIG. 2) by the signature reception unit 131 (see FIG. 5) disposed in the protection area (enclave) 130 (see S405).

The CPU 100 performs signature verification of the signature (FPGA) 223 provided to the output value 13 using the public key (FPGA) 222 as indicated by a reference sign r in FIG. 25 (see S406).

As illustrated in FIG. 23, the CPU 100 inputs the input value 12, the circuit information 11, the public key (CPU) 401, and the signature (CPU) 402, and generates the hash value (input value) 142 and the hash value (circuit information) 143 using the hash function (CPU) 141 (see S407).

<Output Result Transmission> has been described above.

### [Effects]

As described above, an integrity verification system for circuit information 11 includes a CPU 100 and an FPGA 200 that performs specific processing of an application offloaded from the CPU 100, and verifies integrity of the circuit information 11 between the CPU 100 and the FPGA 200, in which the CPU 100 includes a protection area (enclave) 130 for preventing tampering, and includes, in the protection area (enclave) 130, a signature verification unit 132 that verifies a signature of the circuit information 11 signed by a development PC 10 and transmitted to a concerned CPU 100, and a signature replacement unit 135 that replaces a signature (signature provider) 53 verified by the signature verification unit 132 with a signature (CPU) 402 using a public key (public key (CPU) 401) of a concerned CPU 100 before the circuit information 11 is transmitted to the FPGA 200, and the FPGA 200, in a case where an input value 12 is transmitted from the CPU 100, performs calculation on the basis of the input value 12, adds hash values of the input value 12 and the circuit information 11 and a signature (signature (FPGA) 233) to an output value of the calculation, and transmits the output value to the CPU 100.

Accordingly, public keys managed in the FPGA 200 can be reduced by a signature being replaced in the CPU 100, and thus, the processing load of the FPGA 200 can also be reduced. Furthermore, since the CPU 100 can verify a result from the FPGA 200, integrity that the circuit information 11 and the like are not tampered with can be confirmed. That is, the CPU 100 can verify the correctness of important information (whether the calculated value is correct or whether there is tampering of communication between the protection area (enclave) 130 and the FPGA 200).

In the CPU 100 of the integrity verification system 1 for circuit information, in which the signature verification unit 132 verifies a signature of the input value 12 signed by an input value generation source 300 and transmitted to a concerned CPU 100, and the signature replacement unit 135 replaces a signature verified by the signature verification unit 132 with a signature using a key (public key (CPU) 401) of a concerned CPU 100 before the input value 12 is transmitted to the FPGA 200.

Accordingly, the integrity that the circuit information 11 and the like are not tampered with can be confirmed.

In the integrity verification system 1 for circuit information, the development PC 10 signs the circuit information 11 by a signature provider 50 guaranteed by a trusted third party (CA).

Accordingly, the integrity that the circuit information 11 and the like are not tampered with can be confirmed, and the processing load of the FPGA can be reduced.

In the integrity verification system 1 for circuit information, a signature generation unit 134 that, after calculating a hash value (CPU) 152 of the circuit information 11, performs signing (signature (CPU) 403) using the hash value (CPU) 152 and the secret key (CPU) 402, in which the signature verification unit 132 performs signature verification by comparing the hash value (CPU) 152 of the circuit information 11 with a hash value calculated by the signature provider 50 (calculated from the received signature (CPU) 403 and the public key (CPU) 401).

Accordingly, the signature verification unit 132 performs signature verification by comparing the hash value (CPU) 152 of the circuit information 11 with the hash value calculated by the signature provider 50, so that integrity that the replacement itself is not tampered with can be confirmed prior to the replacement of the signature (CPU) 402 by the signature replacement unit 135.

In the integrity verification system 1 for circuit information, the signature verification unit 132 verifies a hash value and a signature transmitted from the FPGA 200.

Accordingly, the integrity that the circuit information 11 and the like are not tampered with can be confirmed.

In the integrity verification system 1 for circuit information, the FPGA 200 registers a public key in advance among the public key and a secret key generated by the CPU 100, and verifies a signature of the circuit information 11 signed by the CPU 100 and transmitted to a concerned FPGA 200 using the registered public key.

Accordingly, the processing load of the FPGA 200 can be reduced.

### [Others]

Among the individual processing described in the above and principle description and embodiment, all or part of the processing described as being automatically performed can be manually performed, or all or part of the processing described as being manually performed can be automatically performed by a known method. In addition to this, information including the processing procedures, the control procedures, the specific names, the various kinds of data, and the parameters mentioned above in the specification or illustrated in the drawings can be modified as desired, unless otherwise particularly specified.

In addition, each component of each device that has been illustrated is functionally conceptual, and is not necessarily physically configured as illustrated. That is, a specific form of distribution and integration of devices is not limited to the illustrated form, and all or some of the devices can be functionally or physically distributed and integrated in any unit in accordance with various loads, usage conditions, and the like.

In addition, some or all of the above-described configurations, functions, processing units, processing means, and the like may be implemented by hardware, for example, by designing with an integrated circuit. In addition, each of the above-described configurations, functions, and the like may be implemented by software for interpreting and performing a program for the processor to implement each function. Information such as a program, a table, and a file for implementing each function can be held in a recording device such as a memory, a hard disk, and a solid state drive (SSD), or a recording medium such as an integrated circuit (IC) card, a secure digital (SD) card, and an optical disk. In addition, in the present specification, the processing steps describing the time-series processing include not only processing performed in time series according to the described order, but also processing performed in parallel or individually (for example, parallel processing or processing by an object) and not necessarily performed in time series.

### REFERENCE SIGNS LIST

1 Integrity verification system for circuit information
10 Development PC
11 Circuit information
12 Input value
13 Output value
50 Signature provider (signature providing device)
52 Public key (signature provider)
53 Signature (signature provider)
100 CPU
130 Protection area (enclave)
131 Signature reception unit
132 Signature verification unit
133 Key pair generation unit
134 Signature generation unit
135 Signature replacement unit
136 Signature transmission unit
152 Hash value of circuit information
200 FPGA (accelerator)
210 Arithmetic circuit
211 Hash function unit
212, 231 Hash value (input value)
222 Public Key (FPGA)
223 Secret Key (FPGA)
232 Hash value (circuit information)
233 Signature (FPGA)
300 Input value generation source
401 Public Key (CPU)
402 Secret Key (CPU)
403 Signature (CPU)

1. An integrity verification system for circuit information configured to verify integrity of circuit information between a CPU and an accelerator, the integrity verification system comprising the CPU and the accelerator wherein the CPU comprises a protection area for preventing tampering, and the protection area comprises:
a signature verification unit, including one or more processors, configured to verify a signature of the circuit information signed by a development PC and transmitted to a concerned CPU; and
a signature replacement unit, including one or more processors, configured to replace a signature verified by the signature verification unit with a signature using a key of the concerned CPU before the circuit information is transmitted to the accelerator; and
the accelerator is configured to perform specific processing of an application offloaded from the CPU, wherein in response to receiving, from the CPU, an input value, the accelerator is configured to:
calculation on a basis of the input value;
add hash values of the input value, the circuit information, and a signature to an output value of the calculation; and
transmit the output value to the CPU.

2. The integrity verification system for circuit information according to claim 1,
wherein the signature verification unit is configured to verify a signature of an input value signed by an input value generation source and transmitted to a concerned CPU; and
wherein the signature replacement unit is configured to replace a signature verified by the signature verification unit with a signature using a key of a concerned CPU before the input value is transmitted to the accelerator.

3. The integrity verification system for circuit information according to claim 1, wherein the development PC signs the circuit information by a signature providing device guaranteed by a trusted third party.

4. The integrity verification system for circuit information according to claim 3, further comprising:
a signature generation unit, including one or more processors and after calculating a hash value of the circuit information, is configured to perform signing in which calculation using a hash value and a secret key is performed,
wherein the signature verification unit is configured to perform signature verification by comparing a hash value of the circuit information with a hash value calculated by the signature providing device.

5. The integrity verification system for circuit information according to claim 1, wherein the signature verification unit is configured to verify a hash value and a signature transmitted from the accelerator.

6. The integrity verification system for circuit information according to claim 1, wherein the accelerator is configured to:
register a public key in advance among the public key and a secret key generated by the CPU; and
verify a signature of the circuit information signed by the CPU and transmitted to a concerned accelerator using the registered public key.

7. An integrity verification method for circuit information for verifying integrity of circuit information between a CPU and an accelerator performed by an integrity verification system, the integrity verification system comprises the CPU and the accelerator,
wherein the accelerator is configured to perform specific processing of an application offloaded from the CPU,
wherein the CPU, comprises a protection area for preventing tampering, and the integrity verification method comprises:
verifying, by the CPU, a signature of the circuit information signed by a development PC and transmitted to a concerned CPU;
replacing, by the CPU, the verified signature with a signature using a key of the concerned CPU before the circuit information is transmitted to the accelerator; and
in response to receiving, from the CPU, an input value, performing, by the accelerator, calculation on a basis of the input value;
adding, by the accelerator, hash values of the input value, the circuit information, and a signature to an output value of the calculation; and
transmitting, by the accelerator, the output value to the CPU.
